(19) United States
(12) Patent Application Publication
(10) Pub. No.: US 2026/0334445 A1
(43) Pub. Date: Oct. 29, 2026

(54) VIEWING DEVICE FOR ICE FISHING

(71) Applicant: Thomas Rolfes, Dalbo, MN (US)

(72) Inventor: Thomas Rolfes, Dalbo, MN (US)

(21) Appl. No.: 19/658,007

(22) Filed: Apr. 24, 2026

Related U.S. Application Data
(63) Continuation of application No. 30/000,927, filed on Apr. 24, 2025.
(60) Provisional application No. 63/794,224, filed on Apr. 24, 2025.

(51) Int. Cl. A01K 97/01; A01K 93/00

(52) U.S. Cl. CPC A01K 97/01; A01K 93/00

(57) ABSTRACT

The present disclosure provides a viewing device for ice fishing, comprising a sleeve configured to be inserted into an ice fishing hole. The sleeve has an interior surface defining a passageway between an upper opening and a lower opening. A reflective surface is positioned on the interior surface of the sleeve, configured to reflect an image of a visual indicator of fishing activity, such as a bobber or float, located at or near the water surface. A rim is disposed at an upper portion of the sleeve, configured to support the sleeve on an ice surface. The reflective surface enables a user positioned at a lateral distance from the ice hole to observe the visual indicator indirectly, without needing to lean over the ice hole, thereby improving comfort, safety, and visibility during ice fishing.

### CROSS-REFERENCE TO RELATED APPLICATIONS

This application claims priority to U.S. Provisional Application No. 63/794,224, filed Apr. 24, 2025, this application is also a continuation application of U.S. Design application Ser. No. 30/000,927, filed Apr. 24, 2025. Said applications are incorporated herein by reference in their entireties.

### TECHNICAL FIELD

The present disclosure relates to viewing devices for ice fishing, and more particularly to a viewing device with an integrated reflective surface configured to enable indirect observation of objects located at or below the water surface through an ice fishing hole.

### BACKGROUND

Ice fishing is a popular winter activity that involves catching fish through holes drilled in frozen bodies of water. Anglers typically use specialized equipment to create openings in the ice, to keep the ice hole open, and deploy fishing gear into the water below. The position of the angler relative to the hole, the thickness of the ice, or the geometry of the ice hole or equipment can obstruct the angler's line of sight to a bobber, float, or other visual indicator located at or near the water surface.

Various methods have been employed to observe fishing activity and to detect fish strikes or during ice fishing. These include the use of sonar, underwater cameras, and traditional techniques such as watching the fishing line or relying on tactile feedback. Some anglers position themselves directly over the ice hole for visual access, but this may be inconvenient, uncomfortable, or impractical in many situations.

There remains a need for improved viewing devices that allow indirect visual access to surface-level indicators such as bobbers or floats when direct line of sight is blocked. Enhanced visual feedback can improve strike detection, angler awareness, and overall user experience during ice fishing. Certain solutions may also allow visual access to underwater environments or reflective viewing of submerged objects, depending on mirror placement and angle.

### SUMMARY

According to an aspect of the present disclosure, a viewing device for ice fishing is provided that provides access to a body of water through ice. The viewing device includes a sleeve configured to be inserted into an ice fishing hole, an interior surface of the sleeve defining a passageway between an upper opening and a lower opening. The viewing device also includes a reflective surface disposed on the sleeve, the reflective surface configured to reflect an image of a visual indicator of fishing activity located at or near a water surface. The viewing device further includes a rim disposed at an upper portion of the sleeve, the rim configured to support the sleeve on an ice surface, or in a hole on the floor of an ice fishing house.

According to other aspects of the present disclosure, the viewing device may include one or more of the following features. The reflective surface may be disposed along an interior circumference of the sleeve, the reflective surface extending substantially along the entire interior circumference. The visual indicator of fishing activity may comprise a bobber. The sleeve may be made of a transparent or translucent material to allow ambient light to enter the sleeve. The viewing device may further comprise a mounting portion on the rim configured to secure the sleeve to the ice surface. The angle of the reflective surface relative to the vertical axis of the sleeve may be adjustable. The sleeve may have a tapered shape with a flared wider upper portion and a narrower lower portion. The reflective surface may be coated with an anti-fogging material.

According to another aspect of the present disclosure, a method of manufacturing a viewing device for ice fishing is provided. The method includes forming a cylindrical sleeve having an interior surface defining a passageway between an upper opening and a lower opening. The method also includes positioning a reflective surface within the sleeve at an angle relative to a vertical axis of the sleeve. The method further includes attaching a rim to an upper portion of the sleeve, wherein the rim is configured to support the sleeve on an ice surface, or with respect to the floor of an ice fishing house.

According to other aspects of the present disclosure, the method may include one or more of the following features. Forming the cylindrical sleeve may comprise molding a transparent or translucent material. The method may further comprise applying an anti-fogging coating to the reflective surface. Positioning the reflective surface may comprise securing a curved mirror within the sleeve. The curved mirror may be formed of a strip of a transparent polycarbonate or other polymer with a mirror surface on one side surface. The method may further comprise configuring the curved mirror to be adjustable to different angles relative to the vertical axis of the sleeve. The method may further comprise forming the sleeve with a tapered shape with a flared upper end.

According to another aspect of the present disclosure, a system for underwater observation in ice fishing is provided. The system includes a viewing device including a sleeve configured to be inserted into an ice fishing hole, or a hole in the floor of an ice fishing house, providing access to a hole in the ice therebelow, the sleeve having an upper opening, a lower opening, and a passageway extending therebetween. The system also includes a reflective surface positioned within the sleeve at an angle relative to a vertical axis of the sleeve. The system further includes a rim disposed at an upper portion of the sleeve, the rim configured to support the sleeve on an ice surface. The system is configured to reflect an image of a visual indicator of fishing activity through the upper opening of the sleeve toward a user positioned at a lateral distance from the ice fishing hole.

According to other aspects of the present disclosure, the system may include one or more of the following features. The reflective surface may be curved to provide a wider field of view of the underwater environment. The sleeve may be made of a transparent or translucent material to allow ambient light to enter the sleeve. The system may further comprise a mounting mechanism on the rim configured to keep the sleeve upper end above the ice surface. The sleeve may have a tapered shape with a wider upper portion, including a flared lip, and a narrower lower portion, and the interior surface of the mirror in the sleeve may be coated with an anti-fogging material.

### BRIEF DESCRIPTION OF THE DRAWINGS

The disclosure can be understood in consideration of the following detailed description of various embodiments in connection with the accompanying drawings.

FIG. 1 is a conceptual diagram illustrating an example viewing device for ice fishing.

FIG. 2 is a conceptual diagram illustrating an example viewing device for ice fishing.

FIG. 3 is a conceptual diagram illustrating an example viewing device for ice fishing.

FIG. 4 is a conceptual diagram illustrating an example viewing device for ice fishing.

FIG. 5 is a conceptual diagram illustrating an example viewing device for ice fishing.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

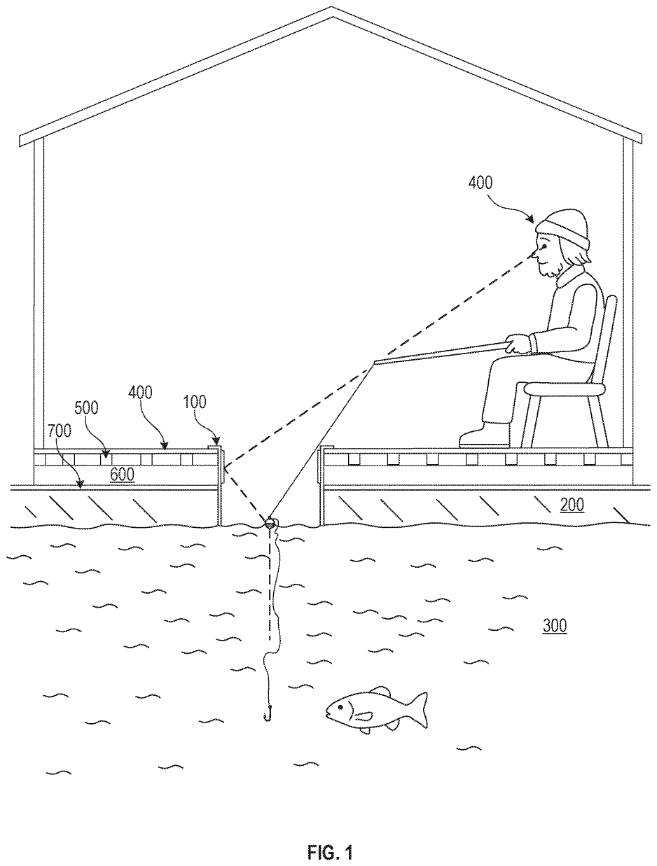

FIG. 1 is a conceptual diagram illustrating an example ice fishing scenario in which fisherman 400 is seated at a distance from an ice hole. Fisherman 400 may be positioned at a lateral distance from an ice hole. As used herein, a user, person, or fisherman “positioned a lateral distance from the ice hole” refers to a person who is seated, standing, or otherwise located at a horizontal offset from the vertical axis of the ice hole, such that the direct line of sight to a visual indicator of fishing activity located within the ice hole is obstructed by the geometry of the ice hole or sleeve. The viewing device enables indirect visual observation of the visual indicator by redirecting an image of the indicator via a reflective surface oriented within the sleeve.

In this scenario, viewing device 100 is inserted into the ice hole, extending through ice layer 200 and into water 300. A visual indicator of fishing activity (e.g., bobber, flat, strike indicator, line indicator, etc.) is positioned at or near the water surface within viewing device 100. The geometry of the ice hole, the thickness of the ice layer, and the angle of observation can result in the bobber being obscured by the perimeter of the hole or by structural elements such as the sidewall of an inserted viewing device 100, such that the fisherman seated away from the hole may not have a direct line of sight to the bobber. In such cases, a direct line of sight to the bobber may only be possible if the fisherman leans over the hole, which may be uncomfortable, impractical, or unsafe in cold or icy conditions. The present viewing device addresses this limitation by incorporating an angled reflective surface within a sleeve structure, enabling indirect visual access to the bobber from a distance. This configuration allows the fisherman to remain comfortably seated while still maintaining clear visual awareness of the bobber or float position, enhancing usability and safety during ice fishing.

In some embodiments, viewing device 100 may be particularly advantageous for use in ice fishing houses, where the structural configuration of the raised floor assembly often obstructs a direct line of sight to the water surface. The floor assembly of the ice fishing house may include a top floor panel 400 approximately ¾ inch to 1 inch thick, supported by floor beams 500 such as 2×4 joists, and elevated above the ice surface by skids or rails 600. These structural elements collectively create an air gap—typically about 4 to 6 inches—between the bottom of the floor and the ice surface. The ice surface may be covered with snow 700, such as 1 to 3 inches of snow. Due to the elevation and the presence of the floor structure, a user seated inside the ice fishing house may be unable to directly view the fishing hole or a visual indicator of fishing activity, such as a bobber, floating at or near the water surface.

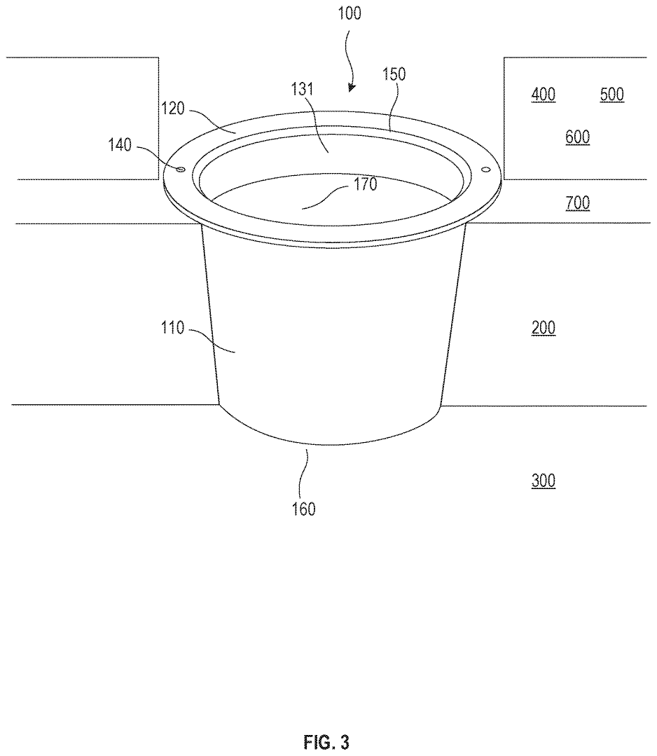

To address this, viewing device 100 may include a rim 120 (e.g., flared flange) that is configured to seat within a hole formed in the floor panel 400 (FIG. 1) or layer of snow 700 (FIG. 3) and to extend downward through the air gap into the underlying hole in the ice. Sleeve 110 of the device may include a reflective surface 130, 131 positioned at an angle. Sleeve 110 may be inserted into an ice hole, and reflective surface 130, 131 can redirect the image of the bobber or float. The configuration enables a user positioned within the fishing house—at a lateral distance from the hole—to indirectly observe fishing activity without needing to lean over or reposition above the hole.

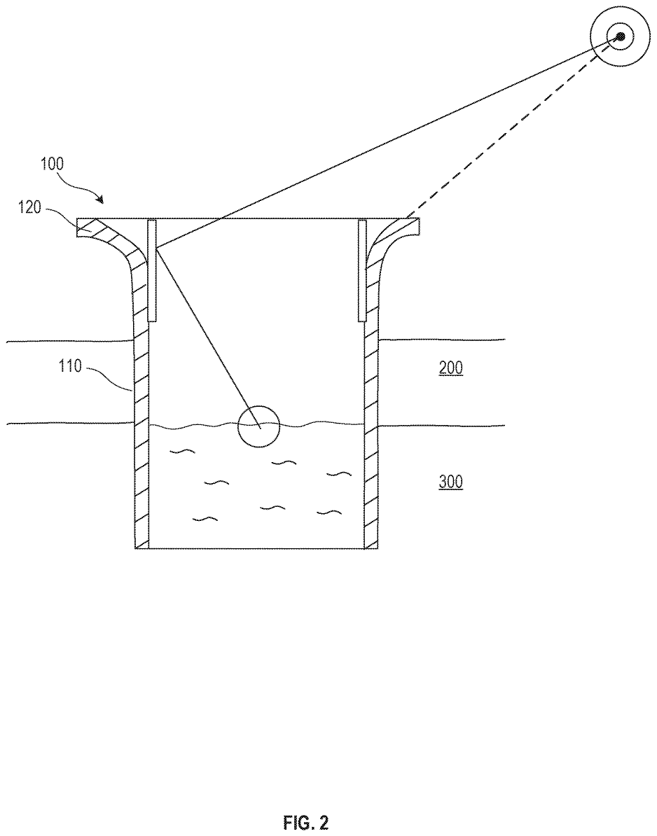

FIG. 2 is a conceptual diagram illustrating a sectional side view of an example viewing device 100 inserted into an ice fishing hole, showing the optical reflection path used to enable indirect visual observation of a bobber. Viewing device 100 includes sleeve 110 extending vertically through ice layer 200 and into water body 300. A bobber is shown floating at or near the water surface within the passageway defined by the sleeve.

Due to the geometry of the ice hole and sleeve 110, and the angle at which a user is typically seated, the direct line of sight to the bobber is obstructed by the upper portion of the wall of sleeve 110 and rim 120. As shown, the eye of fisherman 400, located laterally from the hole, is unable to directly observe the bobber along a straight path. However, a reflective surface (e.g., mirror) is mounted at an angle on the interior of the sleeve near the upper opening. The reflective surface is oriented such that incident light rays from the bobber strike the mirror and are redirected upward and outward through the upper opening, toward the user's eye position.

This optical configuration enables the user to indirectly observe the bobber's position and movement via its reflected image, even when direct visual access is geometrically blocked. The angled mirror thus functions as an optical relay system, effectively extending the user's field of view and allowing monitoring of the bobber without requiring the user to lean over the ice hole.

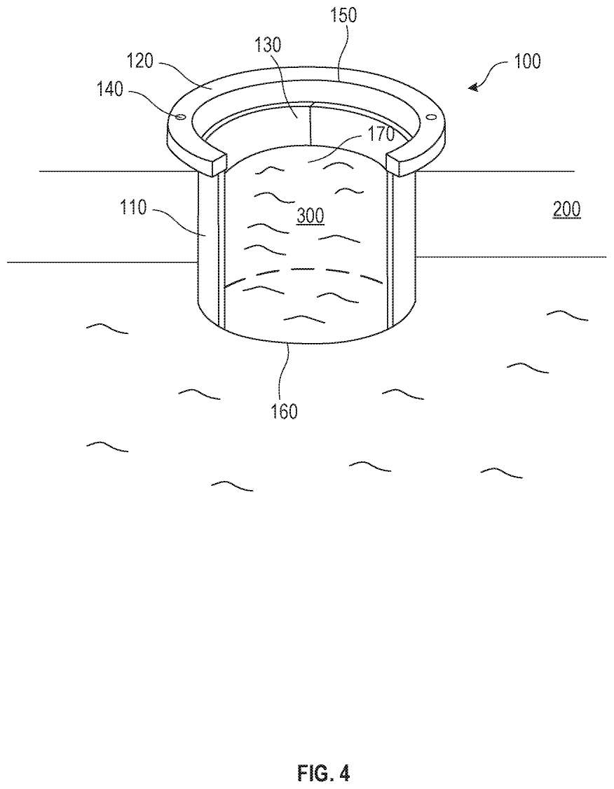

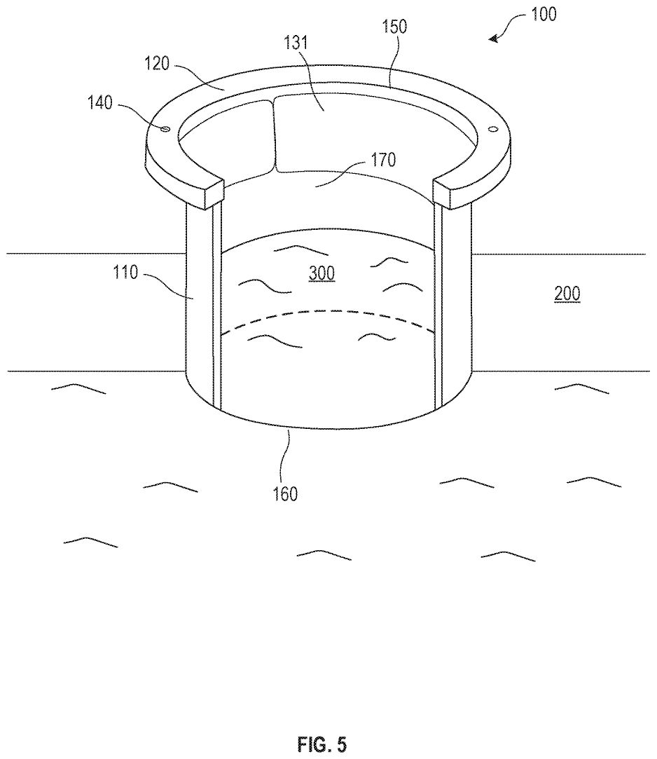

FIGS. 3-5 are conceptual diagrams illustrating an example viewing device 100. The viewing device 100 may be configured for use in ice fishing applications. In some cases, the viewing device 100 may include a sleeve 110, a rim 120, and a reflective surface 130, 131.

Sleeve 110 may be configured to be inserted into an ice fishing hole, extending through an ice layer 200 and into a water body 300. Sleeve 110 may include an interior surface that defines a passageway 170 extending between an upper opening 150 and a lower opening 160. The interior surface may be smooth, coated, or contoured, and may support one or more optical or structural elements, such as a reflective surface 130. Upper opening 150 may be positioned on or above ice layer 200, and lower opening 160 may extend through the ice and into water. Rim 120 may be disposed at an upper portion of sleeve 110. In some cases, rim 120 may be configured to support sleeve 110 on an upper surface of ice layer 200. As shown in FIGS. 3-5, rim 120 may extend radially outward from the upper portion of sleeve 110 beyond the outer diameter of sleeve 110, such that rim 120 is configured to engage an upper surface of ice layer 200 and prevent sleeve 110 from passing entirely through an ice fishing hole. In some cases, the rim 120 may include a mounting mechanism, such as a mounting hole 140. Mounting hole 140 may be configured to receive a fastener or stake to secure viewing device 100 to ice layer 200.

Viewing device 100 may be configured to enable indirect visual observation of a bobber, float, or other target object positioned at or near the water surface in the ice hole, particularly when the user is seated or positioned at a distance away from the hole. In such cases, the reflective surface 130, 131 may redirect the image of the target object upward through the sleeve toward the user's viewing angle, allowing visual access without requiring the user to lean over or be located above the sleeve or ice hole.

In some cases, a reflective surface 130, 131 may be positioned within passageway 170 of sleeve 110 at an angle relative to a vertical axis of the sleeve 110 to reflect an image of a bobber, float, or other visual indicator located at or near the water surface within the ice fishing hole. The angle may optimize the reflection of such target objects through the upper opening 150 by providing a balance between depth perception and viewing area of the underwater environment. In some cases, reflective surface 130, 131 may be positioned at an angle of 30 to 60 degrees relative to a vertical axis of the sleeve 110. In some embodiments, reflective surface 130, 131 is positioned at approximately 45 degrees relative to the vertical axis. Reflective surface 130, 131 may extend around all or a portion of the interior circumference of sleeve 110.

In some cases, the reflective surface extends substantially along the entire interior circumference. As used herein, the term “substantially” refers to an amount, extent, or condition that is largely, but not necessarily entirely, the same as what is specified, and that permits insubstantial or minor deviations that do not materially affect the intended function or purpose. For example, there may be gaps between reflective surface segments, provided that the overall optical coverage and performance are not materially impaired.

In some cases, reflective surface 130, 131 may be curved to provide a wider field of view of the enclosed by the sleeve, including the water surface within the hole and any associated bobber or float. The curved configuration may allow users to observe a larger portion of the fishing hole indirectly without the need to reposition the viewing device 100. Reflective surface 130, 131 may be adjustable to allow users to optimize the viewing angle based on factors such as ice thickness, water depth, or personal preference.

In some embodiments, light from a bobber, lure, or surrounding water surface region within the ice hole may enter the lower opening of sleeve 110 and reflect off reflective surface 130, 131 toward upper opening 150. Reflective surface 130, 131 may be positioned and oriented such that it reflects light from a region located directly beneath or within the vertical column defined by the sleeve and, in some configurations, from areas extending radially outward beyond the outer diameter of the sleeve 110. In particular, reflective surface 130, 131 may be angled and/or curved to intercept light rays entering at oblique angles from within the ice hole or from beneath the surrounding ice, thereby enabling a user to observe regions of interest that may otherwise be obstructed. The expanded field of view may improve situational awareness, float monitoring, lure observation, or identification or obstructions or debris (e.g., weeds) near the hole during ice fishing.

The curved geometry of reflective surface 130, 131 may operate to collect and redirect incident light from a wider area, similar to the behavior of a convex mirror. This configuration may reduce blind spots and allow the user to view movement of a bobber, lure, or related visual targets without repositioning viewing device 100. The curvature may be selected to optimize the balance between magnification and field of view.

As used herein, the term “reflective surface” refers to any surface or structure configured to redirect incident light from a bobber, float, lure, or other target object located at or near the water surface within an ice fishing hole toward a viewing location, such as the upper opening of the sleeve. The reflective surface may be flat, curved, segmented, or continuous, and may include a mirror, a coated surface, a Fresnel lens, a dichroic film, an electrochromic mirror, or any other optical structure capable of reflecting or redirecting light. The curvature may follow a funnel shape of the sleeve. The reflective surface may be fixed or adjustable and may be formed from metallic, polymeric, glass, or composite materials, with or without surface coatings. Example materials include polished metal surfaces (e.g., aluminum, stainless steel), metal-coated polymer films (e.g., silver-or aluminum-coated Mylar® or PET), acrylic or polycarbonate mirror sheets, glass mirrors with a protected reflective backing, Fresnel lenses formed from molded plastic with reflective coatings, dichroic or interference-coated substrates for selective wavelength reflection, electrochromic mirror assemblies capable of switching between reflective and transmissive states. The reflective surface of the sleeve may be coated with an anti-fogging material. The reflective surface may be integrally formed with the sleeve, or removably or fixedly attached to the interior wall of the sleeve using one or more attachment mechanisms. Suitable attachment mechanisms may include: adhesives, such as epoxy, silicone, or pressure-sensitive acrylic-based adhesives, mechanical fasteners, such as clips, brackets, or embedded tabs, slot-and-groove structures formed in the sleeve wall, snap-fit or friction-fit retention features, and magnetic retention when used in combination with ferromagnetic surfaces. In some embodiments, the reflective surface may be mounted at an adjustable angle using a pivoting bracket or track system to allow a user to vary the viewing direction.

In some cases, reflective surface 130, 131 may be a mirror surface. In some cases, reflective surface 130, 131 may include segmented mirror panels. These segmented panels may provide adjustable viewing angles, allowing users to focus on different areas of within or just below the ice hole without moving the entire viewing device 100. In some cases, reflective surface 130, 131 may incorporate a Fresnel lens design that may provide a wider field of view without significantly increasing the bulk of viewing device 100. The Fresnel lens configuration may allow for a more compact reflective surface 130, 131 while maintaining a broad viewing area. In some cases, the reflective surface 130, 131 may have a dichroic mirror coating that may selectively reflect specific light wavelengths, potentially enhancing underwater visibility or highlighting certain features of the underwater environment. Reflective surface 130, 131 may include an electrochromic mirror surface that may be capable of switching between reflective and transparent states, which may provide users with flexibility in how they observe activity in or around the ice hole, potentially allowing for direct viewing through sleeve 110 when desired.

The viewing device 100 may include a mechanism for securing the mirror surface 130 or the reflective surface 131 within the sleeve 110. This mechanism may allow for adjustment of the angle or position of reflective surface 130, 131 relative to the vertical axis of the sleeve 110. The adjustment mechanism may include, for example, pivoting mounts, sliding tracks, or rotatable fixtures that allow users to customize the viewing angle for optimal observation of the underwater environment.

Sleeve 110 and/or rim 120 may have any suitable shape to correspond to the shape of the hole in which it is received, including but not limited to cylindrical, tapered, tubular, elliptical, rectangular, polygonal, or annular configurations. As used herein, the term “annular” refers to any closed-loop structure surrounding a central opening, and may include circular, elliptical, rectangular, or polygonal shapes. In some embodiments, sleeve 110 may have a cylindrical or tubular shape, and the rim 120 may define an annular ring configured to extend radially outward from sleeve 110. In some cases, sleeve 110 may be tapered with a wider upper portion and a narrower lower portion for easier insertion of sleeve 110 into the ice fishing hole while providing stability once installed.

The dimensions of the sleeve may vary depending on the intended use and ice thickness. The length of sleeve 110 may be defined along a longitudinal axis extending through a central axis of sleeve 110. In some cases, sleeve 110 may have a length sufficient to extend through ice layer 200 and into water body 300, as illustrated in FIGS. 3-5. The length may be a length that is above the threshold for safe ice thickness guidelines for ice fishing. In some cases, the length of sleeve 110 may be from about 3 inches to about 24 inches. In some cases, the length of sleeve 110 may be from about 4 inches to about 15 inches. In some cases, the length of sleeve 110 may be from about 7 to about 9 inches. In some cases, the length of sleeve 110 is about 8 inches. The sleeve wall may have a thickness ranging from about 0.1 inch to about 1 inch, depending on the selected material and desired thermal or structural performance. In some embodiments, the sleeve wall may be rigid and formed from molded plastic with a thickness of about 0.125 to 0.375 inches. In other embodiments, the sleeve may include flexible or insulated layers having a composite thickness of up to about 1 inch. The outer diameter of sleeve 110 may correspond to a diameter of an ice fishing hole, which may be determined based on factors such as the species of fish targeted, the auger size used to create the hole, and applicable local regulations. The diameter of sleeve 110 may correspond to a cross-sectional dimension of the sleeve taken along the longitudinal axis or relative to the central axis. In some embodiments, the outer diameter of sleeve 110 may range from about 6 inches to about 24 inches. For example, the outer diameter of sleeve 110 may be approximately 6 inches, 8 inches, 10 inches, 12 inches, or other suitable dimensions.

Rim 120 may define an outer diameter greater than the outer diameter of sleeve 110, where rim 120 is configured to rest on an upper surface of the ice layer and to support sleeve 110 within the ice fishing hole. In some embodiments, the radial extension of rim 120 beyond sleeve 110 may be sufficient to prevent sleeve 110 from falling through the hole formed in the ice. In some embodiments, rim 120 may extend radially outward by about 0.5 inches to about 1.5 inches beyond the outer diameter of sleeve 110. Rim 120 may have a thickness of about 0.25 inches to about 1 inch to provide sufficient structural integrity to support sleeve 110 on the ice without flexing or collapsing. In some cases, rim 120 may be flared may be flared outward relative to the longitudinal axis of the sleeve to increase the surface area contacting the ice layer and provide enhanced structural support. In some embodiments, rim 120 may be attached to or integrally formed with the sidewall of sleeve 110. The connection between rim 120 and the sidewall of sleeve 110 may include a transitional geometry. For example, in some cases, a curved or radiused transition may be formed between the rim and the sleeve sidewall, such that the rim flares outward smoothly from the sleeve body (see FIG. 2). This configuration may reduce stress concentrations, improve aesthetics, or facilitate easier cleaning or molding. In other cases, rim 120 may be attached to sleeve 110 such that a sharp or angular corner is defined between the rim and the sleeve sidewall (see FIG. 1). The sharp-cornered configuration may allow for a compact profile or facilitate certain attachment or mounting geometries. Either configuration may provide sufficient structural support to retain the sleeve within the ice hole.

Sleeve 110 and/or rim 120 may be formed as a unitary structure (e.g., integrally formed) or may be separate structures that are assembled or attached together. Sleeve 110 and/or rim 120 may be formed by any suitable manufacturing process, such as molding, machining, thermoforming, or additive manufacturing. Sleeve 110 and rim 120 may be made from the same or different materials. Sleeve 110 and/or rim 120 may be made of various materials depending on the specific application and environmental conditions. Sleeve 110 and/or rim 120 may be formed from any suitable rigid or flexible material that provides one or more of the following characteristics: structural integrity, water resistance, thermal insulation, or optical clarity. In some cases, sleeve 110 and/or rim 120 may be made of a rigid material that holds shape without collapsing, such as polycarbonate, acrylonitrile butadiene styrene plastic, rigid polyvinyl chloride, high-density polyethylene, or aluminum (e.g., corrosion-resistant aluminum alloy for strength and lightweight properties). In some cases, sleeve 110 and/or rim 120 may be made of flexible or semi-rigid materials for collapsible, portable sleeves, such as neoprene-coated fabric, silicon rubber, thermoplastic elastomers, nylon with polyurethane or polyvinyl chloride coating. In some cases, sleeve 110 and/or rim 120 may be made of insulating materials that help keep light in and heat out or vice versa, such as foamed polyethylene, reflective polyethylene terephthalate film (Mylar), or felted wool or fleece layers. In some cases, sleeve 110 and/or rim 120 may be made of a transparent or translucent material to allow ambient light to enter the sleeve 110 and/or rim 120 for improved visibility of the underwater environment. For example, sleeve 110 and/or rim 120 may be constructed from transparent acrylic (polymethyl methacrylate), polycarbonate, polyethylene terephthalate glycol, and the like. In some embodiments, the sleeve may be formed from an opaque material to block ambient light and enhance the visibility of the underwater environment. The opaque configuration may reduce glare and stray light entering the sleeve, thereby improving image quality when using a reflective surface. The sleeve may be formed from any suitable opaque material, such as acrylonitrile butadiene styrene, high-density polyethylene, polyvinyl chloride, or neoprene-coated fabric, to block ambient light and improve contrast when viewing the underwater environment. In some embodiments, the sleeve may include one or more insulated or laminated opaque layers to provide both structural support and thermal protection. In some cases, the interior surface of the sleeve 110 may be coated with an anti-fogging material. The anti-fogging coating may help maintain clear visibility through sleeve 110 and/or rim 120 by reducing condensation or frost formation on the interior surface.

Rim 120 may be designed with a mounting mechanism or means that includes multiple mounting holes integrated into its structure. These mounting holes may provide various attachment points for securing viewing device 100 to the ice surface. In some cases, the mounting holes may accommodate different types of fasteners, such as screws, bolts, or ice anchors, allowing users to choose the most suitable method for securing the device based on ice conditions and personal preference. In some cases, viewing device 100 may include a mounting mechanism on rim 120. The mounting mechanism may be configured to secure sleeve 110 to the ice surface. This mounting mechanism may take various forms, such as adjustable clamps, threaded inserts, or quick-release fasteners, providing flexibility in how the viewing device 100 is attached to the ice layer 200. Sleeve 110 may incorporate a magnetic mounting system for quick attachment of accessories. In some cases, the magnetic mounting system may be integrated into rim 120 or along the exterior surface of sleeve 110. The magnetic system may allow users to easily attach and detach compatible accessories, such as additional lighting, cameras, or fishing line guides, without the need for tools or permanent modifications to the viewing device 100. The design of rim 120 and its associated mounting features may contribute to the stability and usability of viewing device 100 during ice fishing activities. By providing secure attachment to the ice surface and facilitating the addition of accessories, rim 120 may enhance the functionality and versatility of the viewing device 100 in various ice fishing scenarios.

The sleeve 110 may incorporate illumination, for example a battery and/or a solar-powered lighting system with an external collector. This lighting system may provide illumination within the sleeve 110, potentially improving visibility in low-light conditions. In some cases, the viewing device 100 may include temperature and depth sensors integrated into the sleeve walls. These sensors may provide users with additional information about the underwater environment. The sleeve 110 may incorporate LED strip lights along its interior for illumination. These LED lights may provide even illumination within the sleeve 110, potentially enhancing visibility of the underwater environment. In some cases, the sleeve 110 may incorporate fiber optic lighting integrated into the sleeve walls. This fiber optic lighting may provide glare-free illumination, potentially improving the clarity of the reflected images. The sleeve 110 may have telescoping support arms for adjustable depth placement. These support arms may allow users to adjust the depth of the sleeve 110 within the ice fishing hole, potentially accommodating different ice thicknesses or viewing preferences. In some cases, the sleeve 110 may have an inflatable collar for secure fit in varying hole sizes. This inflatable collar may allow the viewing device 100 to be securely positioned in ice fishing holes of different diameters. The sleeve 110 may have a threaded exterior for compatibility with different ice thickness adapters. This threaded exterior may allow users to attach additional components or adapters to the viewing device 100, potentially increasing its versatility in different ice fishing scenarios.

The viewing device 100 may incorporate UV lights to trigger fluorescence in aquatic organisms. These UV lights may be integrated into the sleeve 110, potentially enhancing the visibility of certain underwater features or organisms. In some cases, the viewing device 100 may include a built-in underwater camera with wireless transmission to a smartphone app. This camera may be positioned within the sleeve 110 to capture images or video of the underwater environment, which may then be transmitted wirelessly to a user's smartphone for real-time viewing or recording. In some cases, the viewing device 100 may include a sonar transducer built into the bottom of the sleeve 110 for fish detection. This sonar transducer may provide users with information about the presence and location of fish in the water body 300 below the ice layer 200. The viewing device 100 may include an augmented reality display system overlaying information on the reflected image. This augmented reality system may provide users with additional data or visual cues superimposed on the reflected underwater image, potentially enhancing the ice fishing experience.

The following patents and patent publications are incorporated herein for all purposes: U.S. Pat. No. 10,688,457; US 2011/0186133; US 2010/00242337; and U.S. Pat. No. 11,856,934.

While the disclosure has been described in connection with what is presently considered to be the most practical and preferred embodiments, it is to be understood that the disclosure is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore, it should be understood that while the use of the word preferable, preferably, or preferred in the description above indicates that feature so described may be more desirable, it nonetheless may not be necessary and any embodiment lacking the same may be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A viewing device for ice fishing, comprising:
a sleeve configured to be inserted into an ice fishing hole, an interior surface of the sleeve defining a passageway between an upper opening and a lower opening;
a reflective surface or surfaces positioned adjacent the upper opening facing inwardly and extending around an interior circumference, the reflective surface or surfaces configured to reflect an image of a visual indicator of fishing activity located at or near a water surface in the sleeve; and
a rim disposed at a flared upper portion of the sleeve.

2. The viewing device of claim 1, wherein the reflective surface is continuous along the interior circumference of the sleeve, the reflective surface extending substantially or entirely along the interior circumference.

3. The viewing device of claim 2, wherein the visual indicator of fishing activity comprises a bobber.

4. The viewing device of claim 1, further comprising a mounting mechanism on the rim configured to secure the sleeve to the ice surface.

5. The viewing device of claim 1, wherein the angle of the reflective surface relative to the vertical axis of the sleeve is adjustable.

6. The viewing device claim 2, wherein the sleeve has a tapered shape with a wider upper portion and a narrower lower portion.

7. The viewing device of claim 1, wherein the reflective surface is coated with an anti-fogging material.

8. A method of manufacturing a viewing device for ice fishing, comprising:
integrally forming a cylindrical sleeve having an interior surface defining a passageway between an upper opening and a lower opening and a rim at an upper portion of the sleeve, wherein the rim is configured to support the sleeve on an ice surface; and
positioning a reflective surface within the sleeve in proximity to an upper flared end of the sleeve.

9. The method of claim 8, wherein forming the cylindrical sleeve comprises molding a transparent or translucent material.

10. The method of claim 8, further comprising applying an anti-fogging coating to the reflective surface.

11. The method of claim 8, wherein positioning the reflective surface comprises securing a curved mirror within the sleeve.

12. The method of claim 11, further comprising configuring the curved mirror to be adjustable to different angles relative to the vertical axis of the sleeve.

13. The method of claim 8, wherein attaching the rim comprises integrating mounting holes into the rim.

14. The method of claim 8, further comprising forming the sleeve with a tapered shape having a wider upper portion and a narrower lower portion.

15. A system for underwater observation in ice fishing, comprising:
a viewing device including a sleeve configured to be inserted into an ice fishing hole, the sleeve having an upper opening, a lower opening, and a passageway extending therebetween;
a reflective surface positioned within the sleeve at an angle relative to a vertical axis of the sleeve;
a rim disposed at an upper portion of the sleeve, the rim configured to support the sleeve on an ice surface; and
wherein the system is configured to reflect an image of a visual indicator of fishing activity through the upper opening of the sleeve toward a user positioned at a lateral distance from the ice fishing hole.

16. The system of claim 15, wherein the reflective surface is curved to provide a wider field of view of the underwater environment.

17. The system of claim 15, wherein the sleeve is made of a transparent or translucent material to allow ambient light to enter the sleeve.

18. The system of claim 15, further comprising a mounting mechanism on the rim configured to secure the sleeve to the ice surface.

19. The system of claim 15, wherein the angle of the reflective surface relative to the vertical axis of the sleeve is adjustable.

20. The system of claim 15, wherein the sleeve has a tapered shape with a wider upper portion and a narrower lower portion, and wherein the interior surface of the sleeve is coated with an anti-fogging material.
